(19) United States
(12) Patent Application Publication
(10) Pub. No.: US 2017/0344945 A1
(43) Pub. Date: Nov. 30, 2017

(54) DETERMINING DIRECTIONS FOR DELIVERING A PRODUCT FROM A VENDOR ASSOCIATED WITH A VENUE TO A USER WITHIN THE VENUE

(71) Applicant: VenueNext, Inc., Santa Clara, CA (US)

(72) Inventors: Peter M. Hennessy, Novato, CA (US); Myles Cagney, Novato, CA (US); John M. Paul, Palo Alto, CA (US)

(21) Appl. No.: 15/169,327

(22) Filed: May 31, 2016

(51) Int. Cl. G06Q 10/08; H04W 4/02; G06Q 30/06; H04W 4/04; G01C 21/34

(52) U.S. Cl. CPC G06Q 10/08355; H04W 4/043; G01C 21/3438; G06Q 30/0635; H04W 4/023

(57) ABSTRACT

An online system associated with a venue provides an application to client devices that allows users to request products from one or more vendors associated with the venue. When the online system receives a request for a product from a vendor associated with the venue from a client device, the online system selects a delivery person to provide the product to the user. Based on a physical location of the client device from which the request was received and a physical location of an additional client device associated with the delivery person, the online system determines directions from the physical location of the additional client device to the physical location of the client device. The online system provides an interface identifying the directions to the additional client device, allowing the delivery person to navigate through the venue to deliver the product to the user.

### BACKGROUND

This invention relates generally to interaction with a venue, and more specifically to facilitating delivery of products from vendors to users in the venue.

Venues such as stadiums, convention centers, amphitheaters, or other locations where people congregate frequently host events that large numbers of users attend. These users compensate the venue in exchange for attending the venue during an event, providing revenue to the venue. Many venues also obtain additional revenue from vendors associated with the venue that provide products, (i.e., goods or services) to users attending the venue.

Certain vendors associated with a venue deliver products to users in or proximate to the venue to facilitate user interaction with the vendors, which may increase revenue obtained by the vendors and to the venue. Conventionally, vendors are able to deliver products to users who specify a particular location in the venue by identifying the particular location to a delivery person who navigates to the particular location with a product. However, if a user moves to another location in the venue, conventional vendors are unable to efficiently redirect a delivery person to the other location to provide a product to the user. Additional, conventional methods for a vendor to deliver a product to a user are unable to account for congestion or movement of other people within a venue to allow a delivery person to more quickly provide a product to a user.

### SUMMARY

A venue is a geographic location, such as a geographic location associated with one or more structures. Examples of a venue include a stadium, a convention center, an arena, a theater, an amphitheater, or other suitable structure or location where people may gather for an event. In various embodiments, users obtain a ticket to enter the venue, and various events are performed at the venue. Additionally, one or more vendors are associated with the venue and provide goods or services to users attending the venue. Examples of vendors include restaurants, food service providers, beverage providers, merchandise retailers, or other suitable entities providing products or services.

To improve user interaction with the venue, an online system is associated with the venue and maintains information associated with users and with vendors associated with the venue. The online system communicates information about the venue or about events occurring at the venue to client devices associated with users of the online system. Additionally, the online system receives orders for products or services from users and communicates the received orders to vendors associated with the venue to be fulfilled.

Additionally, the online system provides an application associated with the online system to various client devices, allowing users of the client devices to order products from vendors associated with the venue via the application. For example, the application identifies various vendors associated with the venue along with products offered by various vendors to a user via a client device executing the application. A user selects a product offered by a vendor by identifying the product via the application, and the application transmits a request for the product to the online system associated with the venue. The request includes an identifier or a description of the product and a physical location of the client device transmitting the request. The physical location of the client device may specify a location within the venue or may specify geographic coordinates (e.g., latitude and longitude) of the client device.

When the online system receives the request for the product from the client device the online system selects a vendor associated with the venue to fulfill the request and transmits the request to the selected vendor. In some embodiments, the request includes an identifier corresponding to a vendor from which the user is requesting the product, so the online system selects the vendor correspond ding to the identifier included in the request. Alternatively, the online system selects a vendor to fulfill the request for the product based on the physical location of the client device included in the request, physical locations associated with various vendors providing the product included in the request, and other information associated with the vendors providing the product included in the request.

The online system or the selected vendor may determine when the selected vendor begins fulfilling the request based on the physical location of the client device. For example, if the physical location of the client device included in the request is greater than a threshold distance from a physical location of the selected client device, the selected vendor does not begin preparing or obtaining the product identified in the request until the online system or the selected vendor determines an updated physical location of the client device is less than the threshold distance of the physical location of the selected vendor. For example, the online system communicates the request to the selected vendor and sends an instruction to fulfill the request when the online system obtains a physical location of the client device that is within the threshold distance of the physical location of the selected vendor. Alternatively, the online system waits to communicate the request to the selected vendor until the online system determines a physical location of the client device obtained by the online system is less than the threshold distance from the physical location associated with the selected vendor. Different threshold distances between the physical location of the client device and a physical location of a vendor may be associated with different vendors. Similarly, different threshold distances between the physical location of the client device and a physical location of a vendor may be associated with different products provided by the vendor. This allows the selected vendor sufficient time to obtain or to prepare the product identified by the request, reducing potential wait times for the user associated with the client device to receive the product identified by the request.

The online system also selects a delivery person associated with the selected vendor to provide the product to the user. In various embodiments, information maintained by the online system for the selected vendor identifies delivery people associated with the selected vendor. The online system may communicate the request for the product to the selected vendor, and the selected vendor selects a delivery person and identifies the selected delivery person to the online system. Alternatively, the online system maintains information describing usage of various delivery people associated with the selected vendor by the selected vendor and selects a delivery person associated with the selected vendor based on the maintained information. An amount of usage of a delivery person by a vendor is an amount of time spent by the delivery person delivering products from the vendor to users within a specific time interval. In an embodiment, the online system associates a different identifier with different delivery people associated with the vendor and captures information identifying an amount of time a delivery person spent delivering products or services from the vendor to users within a time interval (e.g., an hour interval) and maintains a percentage of the time interval spent by different delivery people delivering products or services from the vendor. The online system selects a delivery person based on the percentages of the time interval spent by various delivery people delivering products for the vendor in some embodiments.

Delivery people associated with the selected vendor are each associated with an additional client device executing an application associated with the online system. The application executing on the additional client device may be the application executing on the client device associated with the user that has additional functionality, or may be an alternative application associated with the online system. The additional client devices associated with the delivery people include one or more position sensors. Physical locations of the additional client devices are determined by the position sensors and communicated to the online system, allowing the online system to monitor physical locations of various delivery people based on the physical locations of additional client devices associated with various delivery people.

Based on the physical location of the additional client device associated with the selected delivery person and the physical location of the client device associated with the user who selected the product identified by the request, the online system determines directions from the physical location of the additional client device to the physical location of the client device. The online system may use any suitable method to determine the directions from the physical location of the additional client device to the physical location of the client device. When determining directions from the physical location of the additional client device to the physical location of the client device, the online system may retrieve plans, blueprints, or other information describing layout of the venue. The online system may determine directions that minimize a time for the delivery person associated with the additional client device to reach the physical location associated with the client device or directions that minimize a distance travelled by the delivery person associated with the additional client device to reach the physical location associated with the client device.

Additionally, the online system accounts for conditions in the venue when determining the directions. For example, the online system receives physical locations of client devices executing an application associated with the venue and determines a number of users in various regions of the venue based on the physical locations of the client devices. Based on the determined number of users, the online system determines directions that avoid areas of the venue having greater than a threshold number of users or having greater than a threshold density of users. Similarly, the online system may determine movement of users throughout the venue based on changes in physical locations of client devices associated with the user and determine directions that account for movement patterns of various users to allow the selected delivery person to more efficiently navigate through the venue.

The online system generates an interface that identifies the physical location of the additional client device associated with the selected delivery person and the physical location of the client device associated with the user. Additionally, the interface includes the directions from the physical location of the additional client device to the physical location of the client device. For example, the interface is a map of one or more regions of the venue with the physical location of the additional client device and the physical location of the client device overlaid on the map. In the preceding example, a visual representation of a path between the physical location of the additional client device and the physical location of the client device is also overlaid on the map. The directions may be identified in any suitable format or formats in various embodiments.

In some embodiments, the online system determines an estimated time to travel from the physical location of the additional client device to the physical location of the client device and includes the estimated time in the interface. When determining the estimated time, the online system accounts for numbers of users in regions or other portions of the venue along a path from the physical location of the additional client device to the physical location of the client device described by the directions or movements of users in the regions or the other portions of the venue along the path from physical location of the additional client device to the physical location of the client device described by the directions.

The online system transmits the generated interface to the additional client device, which presents the interface to the selected delivery person via a display device. Hence, after the selected delivery person obtains the product from the selected vendor, the selected delivery person may bring the product to the user by following the interface presented by the additional client device. Because the generated interface may account for conditions in the venue, the directions presented by the interface allow the selected delivery person to more efficiently navigate through the venue to provide the product to the user. If the online system identifies a change in the physical location of the client device associated with the user or in the physical location of the additional client device associated with the selected delivery person, the online system determines modified directions based on the changed physical location or changed physical locations. The online system modifies the interface to identify the modified directions and the changed physical location of the client device or the changed physical location of the additional client device, allowing the interface to provide the delivery person with more accurate directions to navigate to the physical location of the client device.

### BRIEF DESCRIPTION OF THE DRAWINGS

FIG. 1 is a block diagram of a venue, in accordance with an embodiment.

FIG. 2 is a block diagram of a system environment including an online system, in accordance with an embodiment.

FIG. 3 is a block diagram of an online system management system, in accordance with an embodiment.

FIG. 4 a flowchart of a method for directing a delivery person associated with a vendor in a venue to a user who ordered a product from the vendor, in accordance with an embodiment.

FIG. 5 is an example interface including directions from a physical location of a client device associated with a delivery person to a physical location of a client device associated with a user who ordered a product from a vendor, in accordance with an embodiment.

The figures depict various embodiments for purposes of illustration only. One skilled in the art will readily recognize from the following discussion that alternative embodiments of the structures and methods illustrated herein may be employed without departing from the principles of described herein.

### DETAILED DESCRIPTION

### Venue Overview

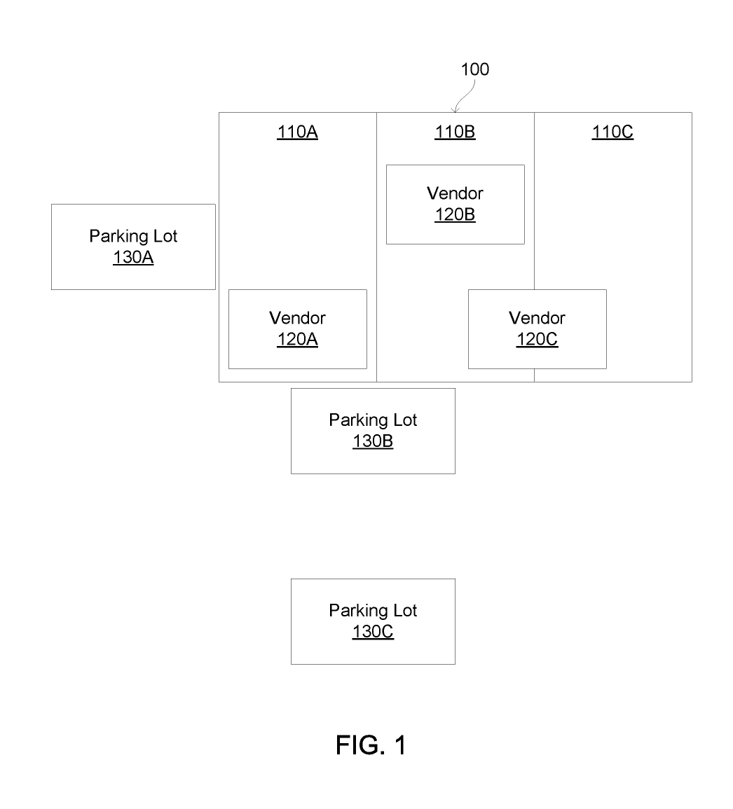

FIG. 1 is a block diagram of one embodiment of a venue 100. In the example of FIG. 1, the venue includes multiple regions 110A, 110B, 110C (also referred to individually and collectively using reference number 110). Additionally, one or more vendors 120A, 120B, 120C (also referred to individually and collectively using reference number 120) are included in the venue 100, and one or more parking lots 130A, 130B, 130C (also referred to individually and collectively using reference number 130) are associated with the venue 100. However, in other embodiments, different and/or additional components may be associated with or included in the venue 100.

The venue 100 is a geographic location, such as a geographic location associated with one or more structures. Examples of a venue 100 include a stadium, a convention center, an arena, a theater, an amphitheater, or other suitable structure. One or more regions 110 are included in the venue 100, with each region 110 corresponding to an area within the venue 100. For example, different regions 110 correspond to different sections of a stadium, different aisles of a stadium or arena, different rooms in a convention center, or any other suitable area within the venue 100. In some embodiments, an area within the venue 100 is associated with multiple regions 110 having different levels of precision. For example, a specific seat in a venue 100 is associated with a region 110 identifying a section including the seat, another region 110 identifying an aisle within the section including the seat, and an additional region identifying the specific seat. While FIG. 1 shows an example venue 100 including three regions 110A, 110B, 110C, in other embodiments, a venue 110 may include any number of regions 110.

One or more vendors 120 are included in the venue 110, with each vendor providing products or services to users within the venue 110. Examples of vendors 120 include restaurants, food service providers, beverage providers, merchandise retailers, or other suitable entities providing products or services. Different vendors 120 may be associated with different regions 110 of the venue. For example, a vendor 120A is associated with a region 110A, while a different vendor 120B is associated with a different region 110B. A vendor 110 may be associated with multiple regions 110; for example, a vendor 110C is associated with a region 110B as well as with an additional region 110C. In some embodiments, a vendor 120 is associated with a region 110 based on a distance between the vendor 120 and the region 110. For example, the vendor 120 is associated with a region 110 having a minimum distance from a location associated with the vendor 120. If a location associated with a vendor 120 is within a region 110, the vendor 120 is associated with the region 110 including the vendor's associated location.

Additionally, one or more parking lots 130A, 130B, 130C are associated with the venue 110 and identify physical locations for parking vehicles. Each parking lot includes one or more spaces, each space for parking a vehicle. A price is associated with each parking lot 130 specifying an amount of compensation a user provides to an entity associated with the venue 110 for a space in the parking lot 130 to be allocated for parking a vehicle associated with the user. Different parking lots 130 may have different distances from the venue 110, and prices associated with different parking lots 130 may be inversely proportional to a distance between a parking lot 130 and the venue 110. Each parking lot 130 is also associated with a capacity specifying a maximum number of vehicles that may be parked in a parking lot 130. The capacity may be total number of spaces in the parking lot 130 or may be a maximum number of vehicles. Information may be maintained by one or more devices included in a parking lot 130 specifying a number of spaces in the parking lot 130 in which vehicles are parked, specifying a number of vehicles within a geographic area associated with the parking lot 130, or any other suitable information. For example, a device included in the parking lot 130 increments a counter when a vehicle enters the geographic area associated with the parking lot 130 or when a vehicle is parked in a space of the parking lot 130.

### System Architecture

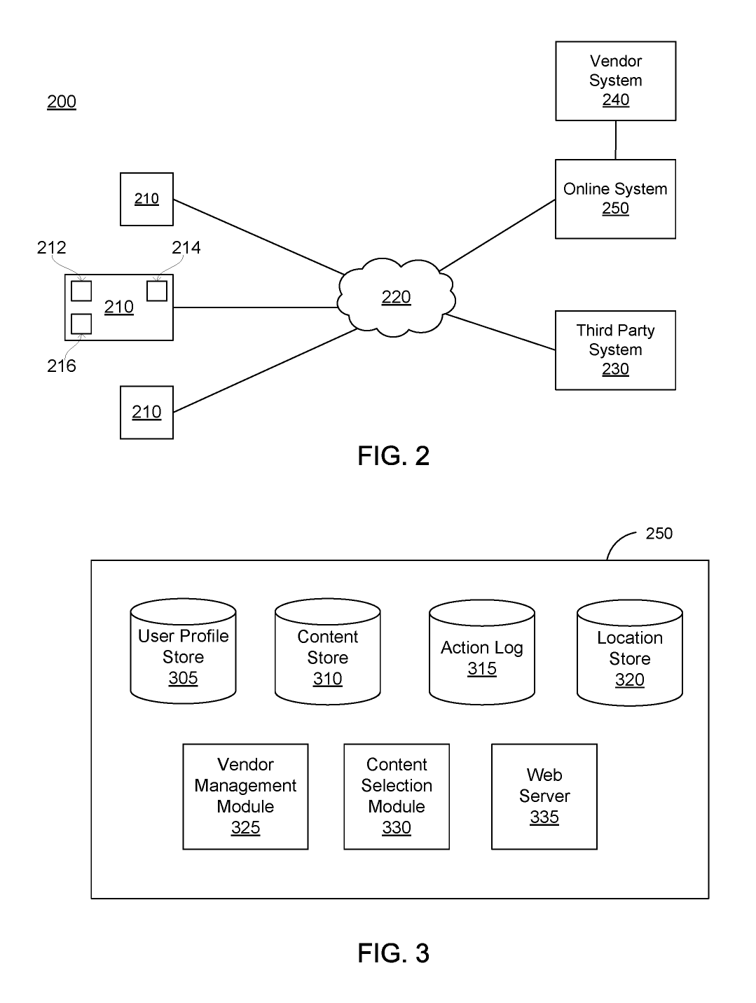

FIG. 2 is a block diagram of a system environment 200 for an online system 250. The system environment 200 shown by FIG. 1 includes various client devices 210, a network 220, a third party system 230, one or more vendor systems 240, and an online system 250. In alternative configurations, different and/or additional components may be included in the system environment 200. The embodiments described herein may be adapted to online systems other than venue management systems.

A client device 210 is one or more computing devices capable of receiving user input as well as transmitting and/or receiving data via the network 220. In one embodiment, the client device 210 is a conventional computer system, such as a desktop computer or a laptop computer. Alternatively, the client device 210 may be a device having computer functionality, such as a personal digital assistant (PDA), a mobile telephone, a smartphone or another suitable device. A client device 210 is configured to communicate with other devices via the network 220. In one embodiment, the client device 210 executes an application allowing a user of the client device 210 to interact with the online system 250. For example, the client device 210 executes a browser application to enable interaction with the online system 250 or with one or more third party system 230 via the network 220. In another embodiment, a client device 210 interacts with the online system 250 through an application programming interface (API) running on a native operating system of the client device 210, such as IOS® or ANDROIDTM

A display device 212 included in a client device 210 presents content items to a user of the client device 210. Examples of the display device 212 include a liquid crystal display (LCD), an organic light emitting diode (OLED) display, an active matrix liquid crystal display (AMLCD), or any other suitable device. Different client devices 210 may have display devices 212 with different characteristics. For example, different client devices 212 have display devices 212 with different display areas, different resolutions, or differences in other characteristics.

One or more input devices 214 included in a client device 210 receive input from the user. Different input devices 214 may be included in the client device 210. For example, the client device 210 includes a touch-sensitive display for receiving input data, commands, or information from a user. Using a touch-sensitive display allows the client device 210 to combine the display device 212 and an input device 214, simplifying user interaction with presented content items. In other embodiments, the client device 210 may include a keyboard, a trackpad, a mouse, or any other device capable of receiving input from a user. Additionally, the client device may include multiple input devices 214 in some embodiments. Inputs received via the input device 214 may be processed by an application associated with the online system 250 and executing on the client device 210 to allow a client device user to exchange information with the online system 250.

Additionally, a client device 210 may include one or more position sensors 216, which determine a physical location associated with the client device 210. For example, a position sensor 216 is a global positioning system (GPS) sensor that determines a physical location associated with the client device 210 based on information obtained from GPS satellites communicating with the GPS sensor, such as coordinates specifying a latitude and longitude of the location associated with the client device 210. As another example, a position sensor 216 determines a location associated with the client device 210 based on intensities of signals received from one or more access points (e.g., wireless access points) by the client device 110. In the preceding example, the position sensor 216 determines a location associated with the client device 210 based on signal intensity between the client device 210 and one or more wireless access points and service set identifiers (SSIDs) or media access control (MAC) addresses of the wireless access points. However, the client device 210 may include any suitable type of position sensor 216. In various embodiments, the client device 210 may include multiple position sensors 216.

The network 220 may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

One or more third party systems 130 may be coupled to the network 220 for communicating with one or more client devices 110 or with the online system 250. In one embodiment, a third party system 230 is an application provider communicating information describing applications for execution by a client device 210 or communicating data to client devices 110 for use by an application executing on the client device 210. In other embodiments, a third party system 230 provides content or other information for presentation via a client device 210. For example, a third party system 230 provides content related to an event occurring at the venue 110 to a client device 210 for presentation to a user; as an example, the third party system 230 provides video or audio data of a portion of an event occurring at the venue to a client device 210, allowing a user associated with the client device 210 to view the portion of the event from an alternative vantage point than the user's vantage point or to hear commentary about the portion of the event. As another example, a third party system 230 is a social networking system maintaining connections between various users and providing content for presentation to users based at least in part on the maintained connections. A third party system 230 may also communicate information to the online system 250, which subsequently communicates the information, or a portion of the information, to one or more client devices 110 via the network 220.

Additionally, one or more vendor systems 240 are coupled to the online system 250 via the network 220 or through direct connections between the vendor systems 240 and the vendor management system 150. A vendor system 240 is associated with a vendor 120 and receives orders for products or services from the online system 250 and provides the products or services identified by the orders. Further, a vendor system 240 provides the online system 250 with information describing fulfilment of orders by a vendor 120 associated with the vendor system 240. For example, the vendor system 240 provides information to the online system 250 specifying an estimated time to fulfill subsequently received or pending orders for products or services, an average time in which previously received orders were fulfilled, a number of unfulfilled orders received by the vendor system 240, or other suitable information. Information provided from the vendor system 240 to the vendor management system 150 accounts for orders received via the vendor management system 150 as well as orders received by the vendor 120 associated with the vendor system 240 from users visiting a location associated with the vendor 120.

Additionally, a vendor system 240 may provide information to the online system 250 describing products or services sold by a vendor 120 associated with the vendor system 240. For example, the vendor system 240 identifies a number of different products or services sold by the vendor 120 or identifies an amount of revenue received by the vendor 120 in exchange for different products or services. Information describing sold products or services may be communicated from the vendor system 240 to the online system 250 as the products or services are sold or may be communicated from the vendor system to the online system 250 at periodic intervals. Additionally, the online system 250 may request information describing sales of products or services to a vendor system 240, which provides the requested information to the online system 250 in response to receiving the request.

The online system 250, which is further described below in conjunction with FIG. 3, receives content from one or more third party systems 230 or generates content and provides content to users via an application associated with the online system 250 and executing on client devices 210. Additionally, the online system 250 maintains information associated with one or more parking lots 130 associated with a venue 100, such as a number of spaces in a parking lot 130 currently occupied, a price associated with a the parking lot 130, or a number of spaces in the parking lot 130 that have been purchased, as well as directions for navigating to a location associated with the parking lot 130. The online system 250 may communicate certain information associated with a parking lot 130 to one or more users, such as the price associated with the parking lot 130 or directions to the location associated with the parking lot 130. Associations between one or more vendors 120 and regions 110 of the venue 100 are also included in the online system 250, which also receives orders for products or services from one or more users and communicates the orders to one or more vendors 120 for fulfillment.

FIG. 3 is a block diagram of an architecture of an online system 250. The online system 250 shown in FIG. 3 includes a user profile store 305, a content store 310, an action log 315, a location store 320, a vendor management module 325, a content selection module 330, and a web server 335. In other embodiments, the social networking system 130 may include additional, fewer, or different components for various applications. Conventional components such as network interfaces, security functions, load balancers, failover servers, management and network operations consoles, and the like are not shown so as to not obscure the details of the system architecture. In other embodiments, the online system 250 is any system providing content to users.

Each user of the online system 250 is associated with a user profile, which is stored in the user profile store 305. A user profile includes declarative information about the user provided by the user and may also include information inferred by the online system 250 from actions associated with the user or from other information. In one embodiment, a user profile includes multiple data fields, each describing one or more attributes of the corresponding user. Examples of information stored in a user profile include demographic information, contact information, preferences, and location information. For example, a user profile identifies a region 110 of the venue 100 associated with a user, such as a region 110 including a seat associated with a ticket to attend the venue 100 associated with the user. A user profile may also store other information provided by the user, for example, image data or video data. Additionally, a user profile in the user profile store 205 may also maintain references to actions by the corresponding user performed on content presented by the online system 250 or interactions between the corresponding user captured by one or more vendor systems 240 and communicated to the online system 250. For example, a user profile identifies prior orders for products or services the online system 250 received from a user and communicated to one or more vendor systems 150.

In some embodiments, a user profile includes a status associated with the user. The online system 250 may provide different functionality to a user based on the user's status. For example, the online system 250 communicates certain types of messages to client devices 210 associated with users having a specific type of status and does not communicate the certain types of messages to client devices 210 associated with users that do not have the specific type of status. As another example, the online system 250 presents less advertisement content to users having specific statuses. The status may be based on a frequency with which the user is associated with tickets to attend the venue 100 or an amount of money the online system 250 has received from the user (e.g., based on an amount the user has spent on tickets to attend the venue 100). Additionally, a user may provide an amount of compensation to the online system 250 for a specific status to be associated with the user. For example, the user provides the online system 250 with an amount of compensation per year or per month for the online system 250 to associate a specific status with the user.

The content store 310 stores objects that each represents various types of content received from one or more third party systems 230 or generated by the online system 250. Examples of content represented by an object include video data associated with an event occurring at the venue 100, image data associated with an event occurring at the venue 100, audio data associated with an event occurring at the venue 100, text data associated with an event occurring at the venue 100, information associated with the venue 100 or with the location of the venue 100, or other suitable. Additionally, content may be received from applications associated with a third party system 230 and executing on client devices 210 associated with users of the venue management system 230. In one embodiment, objects in the content store 210 represent single pieces of content, or content “items.”

The action log 315 stores information describing actions performed by venue management system users internal to or external to the online system 250. For example, actions performed by a user on a third party system 230 that communicates information to the online system 250 are stored in the action log 315 along with information describing actions performed by the user through the online system 250. Examples of actions include: ordering a product or service from a vendor 120 included in the venue 100, checking-into the venue, accessing content provided by the online system 250 or provided by a third party system 230 that communicates with the online system 250, providing a review of a product, service, or vendor 120 to the online system 250 or to a third party system 230 that communicates with the vendor management system 250, providing a comment associated with the venue 100 or with an event occurring at the venue 100 to the online system 250 or to a third party system 230 that communicates with the online system 250. However, any suitable action may be stored in the action log 315 and associated with a user profile in the user profile store 305. Information in the action log 315 may identify the user performing an action, a type of the action, a description of the action, a time associated with the action, or any other suitable information. In some embodiments, data from the action log 315 is used to infer interests or preferences of a user, augmenting interests included in the user's user profile and allowing a more complete understanding of user preferences.

The action log 315 may also store user actions taken on a third party system 230, such as an external website, and communicated to the online system 250. For example, an e-commerce website may recognize a user of the online system 250 through a plug-in enabling the e-commerce website to identify the venue management system user. Because users of the online system 250 are uniquely identifiable, third party systems 230 may communicate information about a user's actions outside of the online system 250 to the online system 250 for association with the user. Hence, the action log 315 may record information about actions users perform on a third party system 230, such as purchases made, comments on content, or other information a user authorizes a third party system 230 to communicate to the vendor management system 250.

The location store 320 includes physical locations associated with various regions 110 of the venue 100. In various embodiments, the location store 320 includes a region identifier associated with each region 110 and information identifying a geographic area associated with the region identifier. Any suitable information may identify the geographic area associated with a region identifier. Example information identifying a geographic area of a region 110 include: physical coordinates specifying boundaries of a region 110 and an identifier of a portion of the venue 100 including the region 110. Additionally, the location store 320 includes data associating vendors 120 with one or more regions 110 of the venue 100. A vendor identifier uniquely associated with a vendor 120 is associated with a region identifier, with the association stored in the location store 320. Multiple vendors 120 may be associated with a region 110 of the venue 100.

In some embodiments, the location store 320 also associates location information with users of the online system 250. A client device 210 communicates location information to the online system 250, which may store the location information in the location store 320 or in the user profile store 305 in association with the user. Based on the received information, the online system 250 may determine a region 110 of the venue including the location information and associate the region identifier of the determined region with a user profile corresponding to the user. If the online system 250 receives modified location information from the client device 210, the venue management system 205 may modify the determined region 110 if a different region includes the modified location information. Alternatively, one or more sensors included in the venue 100 identify a client device 210 and determine a location associated with the client device 210. Based on the determined location, the online system 250 identifies a region 110 including the client device 110 and stores a region identifier of the region 110 in association with a user identifier of a user associated with the client device 210. In various embodiments, information identifying a location associated with the client device 210 (e.g., latitude and longitude) is also stored in the location store 320 in association with an identifier associated with the user associated with the client device 210. Additionally, the online system 250 may assign a location to a user and store the assigned location in association with the user in the location store 320. For example, when a user purchases a ticket to enter the venue 100, the ticket is associated with a location assigned to the user, and the location store 320 includes information associating the location assigned to the user from the ticket with an identifier associated with the user.

The vendor management module 325 receives orders for products (i.e., goods or services) from client devices 210 associated with users and communicates the orders to one or more vendor systems 240 of vendors 120 associated with the venue 100. In various embodiments, the vendor management module 325 includes vendor profiles each associated with one or more vendors 120 associated with the venue 100. A vendor profile includes a vendor identifier uniquely identifying a vendor 120 and additional information associated with the vendor 120, such as one or more regions 110 of the venue 100 associated with the vendor 120 and information for communicating with a vendor system 240 associated with the vendor 120. Further examples of information associated with the vendor 120 and included in a vendor profile include: contact information, hours of operation, a listing of goods or services provided by the vendor 120, a current inventory or products maintained by the vendor 120, and a current time for the vendor 120 to fulfill received orders. However, in other embodiments, additional or different information may be included in the vendor profile. One or more users authorized by the online system 250 may communicate information to the vendor management module 325 to modify regions 110 of the venue associated with one or more vendors 120.

When the vendor management module 325 receives an order, or a request, identifying a product identifying a vendor 120 from a user, the vendor management system 325 communicates the order to a vendor system 240 corresponding to the identified vendor 120. In some embodiments, the vendor management module 325 may select a vendor to fulfill the order based on the product identified in the request. The vendor 120 may subsequently deliver the product identified by the order to the user or may communicate a notification to the user via the online system 250 when the order is fulfilled. To expedite delivery of products or services, the vendor management module 325 may associate different vendors 120 with different regions 110 or the venue 100 to reduce time for users to receive products or services delivered by vendors 120. The vendor management module 325 may modify regions 110 of the venue 100 associated with a vendor 120 by modifying identifiers of regions 110 included in a vendor profile of a vendor 120. In some embodiments, the vendor management module 325 modifies regions 110 associated with a vendor 120 based on a number or a frequency of orders received from users associated with different regions 110 as well as time to fulfill orders by different vendors 120, products or services offered by different vendors 120, and number of orders received by different vendors 120. When modifying regions 110 associated with a vendor 120 or vendors 120 associated with a region, the venue management system 325 may account for products provided by various vendors 120 so similar products are provided to users in a region 110 before and after modification of the vendors 120 associated with the region 110.

Additionally, the vendor management module 325 receives information from a vendor system 240 and communicates the information to one or more client devices 210 for presentation to users. For example, the vendor system 240 communicates a time to fulfill an order, an estimated time to fulfill an order, a number of previously received orders that have yet to be fulfilled, or other suitable information to the vendor management module 325, which provides at least a subset of the information to a client device 210 for presentation to a user. As another example, a vendor system 240 communicates a message to the venue management module 330 including a user identifier, an order identifier (or a description of an order), and an indication that an order corresponding to the order identifier has been fulfilled by a vendor. The vendor management module 325 identifies a user corresponding to the user identifier from the user profile store 305 and communicates the message to a client device 210 associated with the user.

As vendors 120 may deliver products to users in various regions 110 of the venue 100 to fulfill orders received from various users, in some embodiments, the vendor management module 325 regulates communication of orders received from client devices 210 associated with users to vendor systems 240 associated with various vendors 120. When the vendor management module 325 receives an order for a product or service from a client device 210 associated with a user, the vendor management module 325 stores the received order in a queue for a specified time interval before communicating the order to a vendor system 240 corresponding to a vendor 120 identified by the order. If the vendor management system 325 receives additional orders from users having one or more characteristics matching or similar to the order stored in the queue and identifying the vendor 120 identified by the order while the order is stored in the queue, the vendor management module 325 generates a group including the additional orders and the order stored in the queue and communicates the group or orders to a vendor system 240 associated with the vendor 120 to be fulfilled. For example, the vendor management system 325 generates a group including additional orders associated with users having a location matching a location of a user associated with an order stored in the queue. As additional examples, the vendor management system 325 generates a group including orders identifying products or services matching or similar to a product or service specified by an order stored in the queue or generates a group including orders identifying products or services having times for fulfillment within a threshold value of a time for fulfillment of the order stored in the queue. Communicating a group of orders having one or more matching or similar characteristics to a vendor system 240 allows the vendor 120 associated with vendor system 240 to more efficiently fulfill orders from users.

Various vendors 120 may use delivery people to deliver products to users who ordered the products or services from different locations within the venue 100. This allows users in the venue 100 to more conveniently obtain products from the vendor 120 by allowing the users to obtain the products or without physically going to the physical location in the venue 100 of the vendor 120. The vendor management module 325 obtains information for an amount of usage of delivery personnel by one or more vendors 120 to deliver products or services. An amount of usage of delivery personnel by a vendor 120 is an amount of time spent by delivery personnel delivering products or services from the vendor 120 to users within a specific time interval. In an embodiment, the venue management module 325 associates a different identifier with different delivery personnel and captures information identifying an amount of time individual delivery personnel spent delivering products or services from the vendor 120 to users within a time interval (e.g., an hour interval) and maintains a percentage of the time interval spent by individual delivery personnel delivering products or services from the vendor 120 and vendors 120 associated with individual deliver personnel. Based on the percentages of the time interval spent by various delivery personnel delivering products or services, the vendor management module 325 determines an average percentage of the time interval during which delivery personnel delivered products or services to users for various vendors 120. As another example, vendors 120 maintain times for different delivery personnel to deliver products or services to users who ordered the products or services and maintains an average amount of time for delivery personnel to deliver products or services to users from the maintained times and provide the maintained times to the vendor management module 325, which stores the maintained times in association with identifiers of delivery personnel and with vendors 120. Each delivery person is associated with a client device 210 that provides physical location information to the vendor management module 325, allowing the vendor management module 325 to maintain information identifying physical locations of the delivery people.

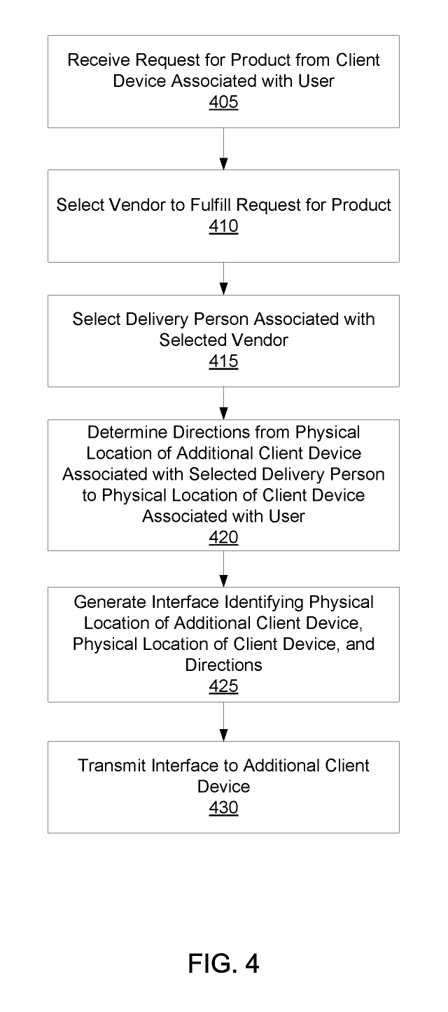

To expedite delivery of a product from a vendor 120 to a user who ordered the product, when the vendor management module 325 receives a request for a product from a client device 210 associated with a user of the online system 250, the vendor management module 325 identifies a physical location of the client device 210 from the request. The vendor management module 325 also selects a delivery person associated with a vendor providing the product and identifies a physical location of the client device 210 associated with the selected delivery person and identifies a physical location of the client device 210 from which the request was received. As further described below in conjunction with FIG. 4, the vendor management module 325 determines directions from the physical location of the client device 210 associated with the delivery person to the physical location of the client device 210 associated with the user. Based on the determined directions, the vendor management module 325 generates an interface identifying the physical location of the client device 210 associated with the user, the physical location of the client device 210 associated with the delivery person, and the directions. The vendor management module 325 transmits the interface to the client device 210 associated with the delivery person, as further described below in conjunction with FIG. 4, allowing the delivery person to navigate to the physical location of the client device 210 associated with the user by viewing the interface on the client device 210 associated with the delivery person. In various embodiments, the venue management system 325 modifies the directions and the interface if a physical location of the client device 210 associated with the user or a physical location of the client device 210 associated with the delivery person changes. Additionally, when determining the directions, the venue management system 325 may account for locations of other users in the venue 100 or movement of users throughout the venue to allow the delivery person to more quickly reach the physical location of the client device 210 associated with the user.

The content selection module 330 selects one or more content items for communication to a client device 210 for presentation to a user. Content items eligible for presentation to the user are retrieved from the content store 310, from a third party system 230, or from another source, by the content selection module 330, which selects one or more of the content items for presentation to the user. A content item eligible for presentation to the viewing user is a content item associated with at least a threshold number of targeting criteria satisfied by characteristics of the user or is a content item that is not associated with targeting criteria. For example, a content item associated with targeting criteria specifying a threshold distance of the venue 100 is identified as eligible for presentation to users associated with locations within a threshold distance of the venue 100. As another example, a content item associated with targeting criteria specifying attendance of an event at the venue 100 is identified as eligible for presentation to users attending the event or who have indicated they will attend the event. In various embodiments, the content selection module 330 includes content items eligible for presentation to the user in one or more selection processes, which identify a set of content items for presentation to the user. For example, the content selection module 330 determines a measure of relevance of various content items to a user based on characteristics associated with the user by the online system 250 based on actions associated with the user by the online system 250, characteristics of the user maintained by the online system 250, preferences of the user maintained by the online system 250, and characteristics of content items eligible for presentation to the user. For example, the content selection module 330 determines measures of relevance to a user based on characteristics of the content items, characteristics of the user, and actions associated with the user. Based on the measures of relevance, the content selection module 330 selects one or more content items for presentation to the user (e.g., content items having at least a threshold measure of relevance, content items having highest measures of relevance relative to other content items). In some embodiments, the content selection module 330 ranks content items based on their associated measures of relevance and selects content items having the highest positions in the ranking or having at least a threshold position in the ranking for presentation to the user.

A content item may be associated with bid amounts specifying an amount of compensation received by the online system 250 from a third party system 130 or from a user if one or more criteria associated with the content item are satisfied. For example, a bid amount associated with a content item specifies an amount of compensation received by the online system 250 when the content item is presented to a user or when a user presented with the content item performs a specified type of interaction with the content item. The content selection module 330 uses the bid amounts associated with various content items when selecting content for presentation to the user. In various embodiments, the content selection module 330 determines an expected value associated with various content items based on their bid amounts and selects content items associated with a maximum expected value or associated with at least a threshold expected value for presentation to the user. An expected value associated with a content item represents an expected amount of compensation to the online system 250 for presenting a content item. For example, the expected value associated with a content item is a product of the content item's bid amount and a likelihood of the user interacting with the content item. The content selection module 335 may rank content items associated with bid amounts separately than content items that are not associated with bid amounts and select content items for presentation based on the separate rankings (e.g., content items having at least a threshold position in a ranking)

The web server 335 links online system 250 via the network 220 to one or more client devices 210, as well as to one or more third party systems 230. Additionally, the web server 335 may exchange information between the online system 250 and one or more vendor systems 240. The web server 335 serves web pages, as well as other content, such as JAVA®, FLASH®, XML and so forth. The web server 335 may receive and route messages between the online system 250 and a client device 210, for example, instant messages, queued messages (e.g., email), text messages, short message service (SMS) messages, or messages sent using any other suitable messaging technique. A user may send a request to the web server 335 to upload information (e.g., images or videos) that are stored in the content store 210. Additionally, the web server 335 may provide application programming interface (API) functionality to send data directly to native client device operating systems, such as IOS®, ANDROID™, or BlackberryOS.

Delivering Products from Vendors Associated with a Venue to Users Who Ordered the Products

FIG. 4 is a flowchart of one embodiment of a method for directing a delivery person associated with a vendor 120 in a venue 100 to a user who ordered a product from the vendor 120. In other embodiments, the method may include different and/or additional steps than those described in conjunction with FIG. 4. Additionally, in other embodiments, steps of the method may be performed in orders different than the order described in conjunction with FIG. 4.

An online system 250 associated with a venue 100, such as a venue management system, maintains information identifying vendors 120 associated with the venue 100. Information identifying a vendor 120 and maintained by the online system 250 describes products provided by the vendor 120. Products may be goods or services provided by the vendor 120 in exchange for compensation. For example, products may be merchandise, food items, consumer goods, or services offered to a user. In various embodiments, the online system 250 includes identifiers each corresponding to various vendors 120 associated with the venue 100 and associates identifiers or other descriptions of products provided by a vendor 120 with an identifier corresponding to the vendor 120.

The online system 250 also obtains information from a vendor 120 associated with a venue 100 that identifies a location within the venue 100 of the vendor 120 and describes a length of time for the vendor 120 to fulfill received orders. The location of the vendor 120 within the venue 100 may identify a region 110 of the venue or may include a physical location. In some embodiments, the location of the vendor 120 within the venue 100 is included in a vendor profile of a vendor 120 maintained by the venue management system 250 and including identifiers of one or more regions 110 associated with the vendor 120. The location of the vendor 120 within the venue 100 may identify portions of a region 110, such as a number of rows within the region 110, in various embodiments. Various criteria may be used to identify the location within the venue 100 of the vendor 120. For example, a location of the vendor 120 within the venue is identified as one or more regions 110 based on a distance between a location associated with the vendor 120 and the regions 110 (e.g., the location of the vendor 120 is identified as regions 110 within a threshold distance of a physical location of the vendor 120).

Additionally, the online system 250 may specify physical locations associated with different vendors 120. A physical location associated with a vendor 120 identifies a physical location within the venue 100 of the vendor 120. In some embodiments, the physical location of the vendor 120 within the venue 100 identifies a region 110 of the venue or may include boundaries of a geographic area. In some embodiments, the physical location of a vendor 120 within the venue 100 and the products offered by the vendor 120 are included in a vendor profile of a vendor 120 maintained by the online system 250 that includes identifiers of one or more regions 110 associated with the vendor 120 and descriptions of products offered by the vendor 120. The physical location of the vendor 120 within the venue 100 may identify portions of a region 110, such as a number of rows within the region 110, in various embodiments. Various criteria may be used to identify the location within the venue 100 of the vendor 120. For example, a physical location of the vendor 120 within the venue is identified as one or more regions 110 based on a distance between a location associated with the vendor 120 and the regions 110 (e.g., the physical location of the vendor 120 is identified as regions 110 within a threshold distance of a physical location of the vendor 120). The online system 250 may maintain other information associated with vendors in various embodiments, such as information further described in U.S. patent application Ser. No. 14/588,242, filed on Dec. 31, 2014, which is hereby incorporated by reference in its entirety

Additionally, the online system 250 provides an application associated with the online system 250 to various client devices 210, allowing users of the client devices 210 to order products from vendors 120 associated with the venue 100 via the application. For example, the application identifies various vendors 120 associated with the venue 100 along with products offered by various vendors 120 to a user via a client device 210 executing the application. A user selects a product offered by a vendor 120 by identifying the product via the application, and the application transmits a request for the product to the online system 250 associated with the venue 100. The request includes an identifier or a description of the product and a physical location of the client device 210 transmitting the request. The physical location of the client device 210 may specify a location within the venue 100 (e.g., a region 110, a portion of a region 110) or may specify geographic coordinates (e.g., latitude and longitude) of the client device 210. In some embodiments, the request also includes information identifying the user associated with the client device 210, such as a user identifier associated with the user by the online system 250 or other information identifying the user (e.g., an e-mail address, a phone number associated with the user, a device identifier of the client device 210, etc.).

When the online system 250 associated with the venue 100 receives 405 the request for the product from the client device 210, the online system 250 selects 410 a vendor 120 associated with the venue 100 to fulfill the request and transmits the request to the selected vendor 120. In some embodiments, the request includes an identifier corresponding to a vendor 120 from which the user is requesting the product, so the online system 250 selects 410 the vendor 120 corresponding to the identifier included in the request. Alternatively, the online system 250 selects 410 a vendor 120 to fulfill the request for the product based on the physical location of the client device 210 included in the request, physical locations associated with various vendors 120 providing the product included in the request, and other information associated with the vendors 120 providing the product included in the request. Selection of a vendor 120 to fulfill a request for a product is further described in U.S. patent application Ser. No. 14/588,242, filed on Dec. 31, 2014, which is hereby incorporated by reference in its entirety.

In various embodiments, the online system 250 or the selected vendor 120 determines when the vendor 120 begins fulfilling the request based on the physical location of the client device 210. For example, if the physical location of the client device 210 included in the request is greater than a threshold distance from a physical location of the selected client device 210, the selected vendor 120 does not being preparing or obtaining the product identified in the request until the online system 250 or the selected vendor 120 determines an updated physical location of the client device 210 is less than the threshold distance of the physical location of the selected client device 210. For example, the online system 250 communicates the request to the selected vendor 120 and sends an instruction to fulfill the request when the online system 250 obtains a physical location of the client device 210 that is within the threshold distance of the physical location of the selected client device 210. Alternatively, the online system 250 waits to communicate the request to the selected vendor 120 until the online system 250 determines a physical location of the client device 210 obtained by the online system 250 is less than the threshold distance from the physical location associated with the selected vendor 250. For example, the online system 250 receives updated physical locations of the client device 210 at periodic intervals and determines distances between updated physical locations of the client device 210 and the physical location associated with the selected vendor; when a distance between a updated physical location of the client device 210, the online system 250 communicates the request to the selected vendor 120 or communicates an instruction to fulfill the request to the selected vendor 120.

The online system 250 may associate different threshold distances between the physical location of the client device 210 and a physical location of a vendor 120 with different vendors. The threshold distance from a physical location of a vendor 120 may be based on services provided by the vendor 120 or information provided by the vendor 120 identifying times for the vendor 120 to prepare or to obtain different products provided by the vendor. Accordingly, the online system 250 may determine the threshold distance from the physical location of the client device 210 and the selected vendor 120 based on the product identified by the request. Different threshold distances associated with different products are maintained by the online system 250 in association with the selected vendor 120. For example, if the selected vendor 120 provides food items having different preparation times, the online system 250 associates various threshold distances with the selected vendor 120 that are each based on a time for the selected vendor 120 to prepare a food item. When the online system 250 receives the request from the client device 210, the online system identifies the product identified or described by the request and determines a threshold distance from the physical location of the client device 210 to the physical location of the vendor 120 associated with the product identified or described the request. This allows the selected vendor 120 sufficient time to obtain or to prepare the product identified by the request, reducing potential wait times for the user associated with the client device 210 to receive the product identified by the request.

The online system 250 also selects 415 a delivery person associated with the selected vendor 120 to provide the product to the user. In various embodiments, information maintained by the online system 250 for the selected vendor 120 identifies delivery people associated with the selected vendor 120. The online system 250 may communicate the request for the product to the selected vendor 120, and the selected vendor 120 selects 415 a delivery person and identifies the selected delivery person to the online system 250. Alternatively, the online system 250 maintains information describing usage of various delivery people associated with the selected vendor 120 by the selected vendor 120 and selects 415 a delivery person associated with the selected vendor 120 based on the maintained information. An amount of usage of a delivery person by a vendor 120 is an amount of time spent by the delivery person delivering products from the vendor 120 to users within a specific time interval. In an embodiment, the online system 250 associates a different identifier with different delivery people associated with the vendor 120 and captures information identifying an amount of time a delivery person spent delivering products or services from the vendor 120 to users within a time interval (e.g., an hour interval) and maintains a percentage of the time interval spent by different delivery people delivering products or services from the vendor 120. The online system 250 selects 415 a delivery person based on the percentages of the time interval spent by various delivery people delivering products for the vendor 120. For example, the online system 250 selects 415 a delivery person associated with the vendor 120 who has spent less than a threshold percentage of the time interval delivering products for the vendor. As another example, the online system 25 ranks the delivery people based on their percentages of time spent delivering products for the vendor 120 and selects 415 a delivery person based on the ranking (e.g., selects 415 a deliver person having a highest or a lowest position in the ranking).

The online system 250 may account for additional factors when selecting 415 a delivery person associated with the selected vendor 120. For example, the online system 250 obtains physical locations of various delivery people associated with the selected vendor 120 and accounts for distances between the physical location of the client device 210 associated with the user and physical locations of delivery people associated with the selected vendor 120 when selecting 415 a delivery person. For example, the online system 250 identifies delivery people associated with the selected vendor 120 having physical locations less than a threshold distance from the physical location of the client device 210 associated with the user in the received request and selects 415 one of the identified delivery people based on their percentages of time spent delivering products for the vendor 120, as described above. Alternatively, the online system 250 selects 415 a delivery person associated with the selected vendor 120 having a physical location that is nearest to the physical location of the client device 210 associated with the user in the received request.

Delivery people associated with the selected vendor 120 are each associated with an additional client device 210 executing an application associated with the online system 250. The application executing on the additional client device 210 may be the application executing on the client device 210 associated with the user that has additional functionality, or may be an alternative application associated with the online system 250. The additional client devices 210 associated with the delivery people include one or more position sensors 216, as described above in conjunction with FIG. 2. Physical locations of the additional client devices 210 are determined by position sensors 216 in the additional client devices 210 and communicated to the online system 250. This allows the online system 250 to monitor physical locations of various delivery people based on the physical locations of additional client devices 210 associated with various delivery people.

Based on the physical location of the additional client device 210 associated with the selected delivery person and the physical location of the client device 210 associated with the user who selected the product identified by the request, the online system 250 determines 420 directions from the physical location of the additional client device 210 to the physical location of the client device 210. The online system 250 may use any suitable method to determine 420 the directions from the additional client device 210 to the client device 210. When determining 420 directions from the physical location of the additional client device 210 to the physical location of the client device 210, the online system 250 may retrieve plans, blueprints, or other information describing layout of the venue 100. In some embodiments, the online system 250 determines 420 directions that minimize a time for the delivery person associated with the additional client device 210 to reach the physical location associated with the client device 210. Alternatively, the online system 250 determines 420 directions that minimize a distance travelled by the delivery person associated with the additional client device 210 to reach the physical location associated with the client device 210. The online system 250 may modify whether directions are determined 420 to minimize the distance travelled or the time to reach the physical location associated with the additional client device 210 based on settings specified by the selected vendor 120 or other information.

Additionally, the online system 250 accounts for conditions in the venue 100 when determining 420 the directions. For example, the online system 250 receives physical locations of client devices 210 executing an application associated with the venue 100 and determines a number of users in various regions 110 of the venue based on the physical locations of the client devices 210. Based on the determined number of users, the online system 250 determines 420 directions that avoid regions 110, or other areas of the venue 100, having greater than a threshold number of users or having greater than a threshold density of users. Similarly, the online system 250 may determine movement of users throughout the venue 100 based on changes in physical locations of client devices 210 associated with the user and determine 420 directions that account for movement patterns of various users to allow the selected delivery person to more efficiently navigate through the venue 100.

The online system 250 generates 425 an interface that identifies the physical location of the additional client device 210 associated with the selected delivery person and the physical location of the client device 210 associated with the user. Additionally, the interface includes the directions from the physical location of the additional client device 210 to the physical location of the client device 210. For example, the interface is a map of one or more regions 110 of the venue 110 with the physical location of the additional client device 210 and the physical location of the client device 210 overlaid on the map. In the preceding example, a visual representation of a path between the physical location of the additional client device 210 and the physical location of the client device 210 is also overlaid on the map. The directions may be identified in any suitable format or formats in various embodiments. Multiple formats may be used to identify the directions in some embodiments. For example, a path between the physical location of the additional client device 210 and the physical location of the client device 210 is overlaid on a map of one or more regions 110 of the venue, and text or audio data providing turn-by-turn directions for the selected delivery person to navigate from the physical location of the additional client device 210 to the physical location of the client device 210.

In some embodiments, the online system 250 determines an estimated time to travel from the physical location of the additional client device 210 to the physical location of the client device 210 and includes the estimated time in the interface. When determining the estimated time, the online system 250 accounts for numbers of users in regions 110 or other portions of the venue 100 along a path from the physical location of the additional client device 210 to the physical location of the client device 210 described by the directions or movements of users in the regions or the other portions of the venue 100 along the path from physical location of the additional client device 210 to the physical location of the client device 210 described by the directions. The estimated time may be included in the generated interface in various embodiments. Additionally, the online system 250 may include instructions in the interface that request updates to the estimated time at different intervals or that receive updates to the estimated time when the online system 250 modifies the estimated time based on changes to conditions in the venue 100 (e.g., changes in a number of users or changes in user movement along one or more portions of a path specified by the directions).

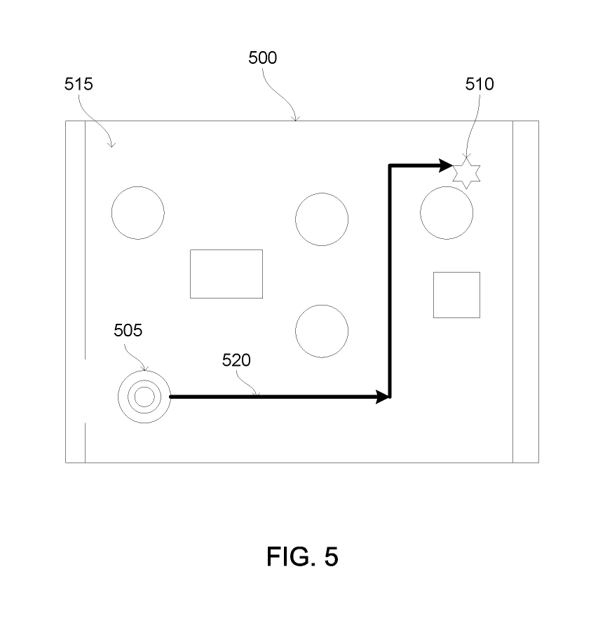

FIG. 5 is an example interface 500 generated by the online system 250. In the example of FIG. 5, the interface 500 includes a representation 505 of the physical location of the additional client device 210 and a representation 510 of the physical location of the client device 210 overlaid on a map 515 of a portion of the venue 100 including the physical locations of the client device 210 and of the additional client device 210. The map 515 includes representations of structures or objects in the venue 100, and may also include representations of other users in the portion of the venue 100 based on physical locations of client devices 210 associated with the other users received by the online system 250. The interface 500 also includes a path 520 corresponding to the directions from the physical location of the additional client device 210 to the physical location of the client device 210 determined by the online system 250. While the path 520 in FIG. 5 is a graphical connection between the physical location of the additional client device 210 to the physical location of the client device 210 shaped based on the determined directions, in other embodiments, the interface 500 may present a textual representation of the determined directions or any other suitable representation of the directions.

Referring again to FIG. 4, the online system 250 transmits 430 the generated interface to the additional client device 210, which presents the interface to the selected delivery person via a display device 212. Hence, after the selected delivery person obtains the product from the selected vendor 120, the selected delivery person may bring the product to the user by following the interface presented by the additional client device 210. Because the generated interface may account for conditions in the venue 100, the directions presented by the interface allow the selected delivery person to more efficiently navigate through the venue to provide the product to the user.

If the online system 250 identifies a change in the physical location of the client device 210 associated with the user or in the physical location of the additional client device 210 associated with the selected delivery person, the online system 250 determines modified directions based on the changed physical location. The online system 250 modifies the interface to identify the modified directions and the changed physical location of the client device 210 or the changed physical location of the additional client device 210. For example, if the physical location of the client device 210 changes by moving more than a threshold distance from the physical location of the client device 210 included in the received request, the online system 250, the online system 250 determines modified directions from the physical location of the additional client device 210 to the changed physical location of the client device 210 and modifies the interface to identify the changed physical location of the client device 210 and the modified directions. In some embodiments, the client device 210 communicates its physical location to the online system 250 at periodic intervals, and the online system 250 identifies a change in the physical location of the client device 210 if a received physical location of the client device 210 differs at least a threshold distance from the location of the client device 210 included in the received request. Alternatively, the client device 210 communicates a changed physical location of the client device 210 to the online system 250 if the application executing on the client device 210 determines a threshold distance from a physical location of the client device 210 at a current time to the physical location of the client device 210 when the request was transmitted to the online system 250. Hence, as the physical location of the client device 210 changes, the interface is modified to account for the changed physical location of the client device 210 and to present modified directions that allow the delivery person associated with the additional client device 210 to navigate to the user associated with the client device 210.

Similarly, if the physical location of the additional client device 210 changes by moving more than a threshold distance from the physical location of the additional client device 210 at a time when the additional client device 210 received the interface, the online system 250 determines modified directions from the changed physical location of the additional client device 210 to the physical location of the client device 210 and modifies the interface to identify the changed physical location of the additional client device 210 and the modified directions. In some embodiments, the additional client device 210 communicates its physical location to the online system 250 at periodic intervals, and the online system 250 identifies a change in the physical location of the additional client device 210 if a received physical location of the additional client device 210 differs at least a threshold distance from the location of the additional client device 210 when the additional client device 210 received the interface. Alternatively, the additional client device 210 communicates a changed physical location of the additional client device 210 to the online system 250 if the application executing on the additional client device 210 determines a threshold distance from a physical location of the additional client device 210 at a current time to the physical location of the additional client device 210 when interface was received by the additional client device 210. Hence, as the physical location of the additional client device 210 changes, the interface is modified to continue providing the additional client device 210 with directions to reach the client device 210. This allows the interface to be updated as the additional client device 210 changes physical location so the additional client device 210 continues presenting directions guiding the delivery person to the physical location of the client device 210.

In various embodiments, the interface includes instructions that when, executed by a processor included in the additional client device 210, prompt the delivery person to move in particular directions. For example, the instructions included in the interface cause the additional client device 210 provide a visual or audible prompt identifying how the delivery person is to move to follow the directions when certain criteria are satisfied. As an example, the instructions included in the interface cause the additional client device 210 to play an audio prompt to the delivery person that recites a portion of the directions when the physical location of the additional client device 210 is within a threshold distance of a physical location within the venue 100 where the directions identify a change in direction of travel (e.g., an audio prompt telling the delivery person to turn left at a particular physical location). Similarly, the instructions may cause the display device 212 of the additional client device 210 to more prominently identify a change in direction of travel to the delivery person when the physical location of the client device 210 is within a threshold distance of the physical location within the venue 100 where the directions identify a change in direction of travel of the delivery person. Including the instructions in the interface transmitted 430 to the additional client device 210 allows the client device 210 to more effectively direct the delivery person to the physical location of the client device 210, reducing a time for the user associated with the client device 210 to receive the product identified by the request. Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a request for a product at an online system associated with a venue from an application associated with the online system executing on a client device, the request identifying the product and a physical location of the client device;
selecting a vendor associated with the venue to fulfill the request for the product based on the service and information maintained by the online system identifying products provided by vendors associated with the venue;
transmitting the request to the selected vendor;
selecting a delivery person associated with the selected vendor to provide the product, the delivery person associated with an additional client device;
determining directions from a physical location of the additional client device to the physical location of the client device;
generating an interface identifying the physical location of the additional client device, the physical location of the client device, and the directions from the physical location of the additional client device to the physical location of the client device; and
transmitting the generated interface to the additional client device for presentation to the delivery person.

2. The method of claim 1, wherein determining directions from the physical location of the additional client device to the physical location of the client device comprises:
determining an estimated time from the physical location of the additional client device to the physical location of the client device.

3. The method of claim 2, wherein the generated interface further identifies the estimated time from the physical location of the additional client device to the physical location of the client device.

4. The method of claim 1, further comprising:
identifying a change in the physical location of the client device;
determining modified directions from the physical location of the additional client device to the changed physical location of the client device;
modifying the interface to identify the changed physical location of the client device, the physical location of the additional client device, and the modified directions from the physical location of the additional client device to the changed physical location of the client device; and
transmitting the modified interface to the additional client device for presentation to the delivery person.

5. The method of claim 1, further comprising:
identifying a change in the physical location of the additional client device;
determining modified directions from the changed physical location of the additional client device to the physical location of the client device;
modifying the interface to identify the physical location of the client device, the changed physical location of the additional client device, and the modified directions from the changed physical location of the additional client device to the physical location of the client device; and
transmitting the modified interface to the additional client device for presentation to the delivery person.

6. The method of claim 1, wherein transmitting the request to the selected vendor comprises:
identifying a threshold distance from a physical location of the selected vendor;
transmitting the request to the selected vendor in response to a physical location of the client device obtained by the online system being less than the threshold distance and the physical location of the selected vendor.

7. The method of claim 6, wherein identifying the threshold distance from the physical location of the selected vendor comprises:
determining the threshold distance from the physical location based on the product identified in the request.

8. The method of claim 1, wherein transmitting the request to the selected vendor comprises:
transmitting the request to the selected vendor;
transmitting an instruction to fulfill the request to the selected vendor in response to the online system determining a physical location of the client device obtained by the online system is less than the threshold distance.

9. A computer program product comprises a computer readable storage medium having instructions encoded thereon that, when executed by a processor, cause the processor to:
receive a request for a product at an online system associated with a venue from an application associated with the online system executing on a client device, the request identifying the product and a physical location of the client device;
select a vendor associated with the venue to fulfill the request for the product based on the service and information maintained by the online system identifying products provided by vendors associated with the venue;
transmit the request to the selected vendor;
select a delivery person associated with the selected vendor to provide the product, the delivery person associated with an additional client device;
determine directions from a physical location of the additional client device to the physical location of the client device;
generate an interface identifying the physical location of the additional client device, the physical location of the client device, and the directions from the physical location of the additional client device to the physical location of the client device; and
transmit the generated interface to the additional client device for presentation to the delivery person.

10. The computer program product of claim 9, wherein determine directions from the physical location of the additional client device to the physical location of the client device comprises:
determine an estimated time from the physical location of the additional client device to the physical location of the client device.

11. The computer program product of claim 10, wherein the generated interface further identifies the estimated time from the physical location of the additional client device to the physical location of the client device.

12. The computer program product of claim 9, wherein the computer readable storage medium further has instructions encoded thereon that, when executed by the processor, cause the processor to:
identify a change in the physical location of the client device;
determine modified directions from the physical location of the additional client device to the changed physical location of the client device;
modify the interface to identify the changed physical location of the client device, the physical location of the additional client device, and the modified directions from the physical location of the additional client device to the changed physical location of the client device; and
transmit the modified interface to the additional client device for presentation to the delivery person.

13. The computer program product of claim 9, wherein the computer readable storage medium further has instructions encoded thereon that, when executed by the processor, cause the processor to:
identify a change in the physical location of the additional client device;
determine modified directions from the changed physical location of the additional client device to the physical location of the client device;
modify the interface to identify the physical location of the client device, the changed physical location of the additional client device, and the modified directions from the changed physical location of the additional client device to the physical location of the client device; and
transmit the modified interface to the additional client device for presentation to the delivery person.

14. The computer program product of claim 9, wherein transmit the request to the selected vendor comprises:
identify a threshold distance from a physical location of the selected vendor;
transmit the request to the selected vendor in response to a physical location of the client device obtained by the online system being less than the threshold distance and the physical location of the selected vendor.

15. The computer program product of claim 14, wherein identify the threshold distance from the physical location of the selected vendor comprises:
determine the threshold distance from the physical location based on the product identified in the request.

16. The computer program product of claim 9, wherein transmit the request to the selected vendor comprises:
transmit the request to the selected vendor;
transmit an instruction to fulfill the request to the selected vendor in response to the online system determining a physical location of the client device obtained by the online system is less than the threshold distance.
